(19) United States
(12) Patent Application Publication
(10) Pub. No.: US 2024/0357235 A1
(43) Pub. Date: Oct. 24, 2024

(54) AN IMAGING SYSTEM WITH A SCANNING MIRROR

(71) Applicants: EUROPEAN SPACE AGENCY, Noordwijk (NL); OHB SYSTEM AG, Weßling (DE)

(72) Inventors: Luca MARESI, Noordwijk (NL); Michael DEIML, Darmstadt (DE); Markus ERHARD, Muenchen (DE)

(21) Appl. No.: 18/687,042

(22) PCT Filed: Sep. 2, 2021
(86) PCT No.: PCT/EP2021/074253

§ 371 Date: Feb. 27, 2024

(51) Int. Cl. H04N 23/69; B64G 1/10; G02B 26/10; H04N 23/12

(52) U.S. Cl. CPC H04N 23/69; B64G 1/1028; G02B 26/105; H04N 23/12

(57) ABSTRACT

The invention relates to an imaging system for imaging a surface on an astronomical body, such as the Earth. The imaging system such as a satellite imaging system comprises a telescope comprising at least first and second curved mirrors wherein the second mirror is located downstream of the first mirror, relative to a propagation direction of imaged light, a digital image sensor or a slit aperture arranged at the focal plane of the telescope, and an actuator system arranged for tilting the second mirror or other curved mirror located down-stream of the first curved mirror for scanning the line of sight of the imaging system in a scanning direction (221) on the surface within a field of view (231) of the imaging system.

### FIELD OF THE INVENTION

The invention relates to imaging systems, particularly to such imaging systems arranged with a scanning mirror for scanning a surface to be imaged from a satellite, an aircraft or other flying platform.

### BACKGROUND OF THE INVENTION

A low Earth orbit satellite telescope is used to image the surface of the Earth onto an image sensor. The maximum integration of the image sensor is defined by the velocity of the satellite ground track and the size on ground of the imaged detector pixels, i.e. the ground sampling distance. A satellite on a typical low Earth orbit of about 700 km will have a ground track speed of approximately 7 km/s. With a ground sampling distance of 26 m, the integration time at which the images starts to be smeared due to the satellite's motion is about 3 ms. If the telescope includes a spectrometer in order to obtain spectrally resolved images, an integration time of 3 ms may be insufficient in view of the reduced intensity and may suffer from a poor signal-to-noise ratio.

Telescopes configured with a push broom scanner can be used to keep the line of sight pointed to the target while the satellite is orbiting above it. With this solution the integration time can be increased and thereby it is possible to increase the signal-to-noise ratio.

Another way to increase the signal-to-noise ratio is to increase the f-number of the telescope.

The above solutions may suffer from high complexity and/or high weight. Accordingly, there is a need for improving telescopes for satellites, with respect to the complexity of the system, the weight or other aims.

### SUMMARY OF THE INVENTION

It is an object of the invention to improve imaging systems such as imaging systems for satellites or aircrafts to alleviate one the above mentioned problems, and therefore to present an imaging system with reduced complexity and weight. It is also an object to present solutions of the imaging system which achieves other improvements in view of known imaging systems.

In a first aspect of the invention there is provided an imaging system for imaging a surface on an astronomical body, such as the Earth, from a platform flying along a trajectory, wherein a line of sight of the imaging system on the surface during the flight defines an along track direction, the imaging system comprises
a telescope comprising at least first and second curved mirrors wherein the second mirror is located downstream of the first mirror, relative to a propagation direction of imaged light,
a digital image sensor or a slit aperture arranged at the focal plane of the telescope, and
an actuator system arranged for tilting the second mirror or other curved mirror located down-stream of the first curved mirror for scanning the line of sight of the imaging system in a scanning direction on the surface within a field of view of the imaging system.

Advantageously, by use of the curved mirror the scanning mirror, the complexity, size and weight of the imaging system is minimized since additional scanning mirrors such as plane scanning mirrors are not required.

Normally, the first mirror of the telescope is larger than the second mirror or other downstream mirror. It is an advantage to use a smaller mirror for the scanning mirror in view of the dimensioning of the actuator system.

Thus, while it is known to arrange the first mirror in an imaging system to be tiltable, this either adds additional components, such as an additional plane mirror, or requires the first mirror, which is larger than the downstream mirrors, to be arranged with a suitably dimensioned tilt actuator, or both.

According to a second aspect, at least the curved mirror arranged for tilting has a surface without any axis of symmetry, such as a freeform surface.

Advantageously, the freeform surface of the mirror enables an imaging system which does not require an additional plane mirror for obtaining the scanning capability since the freeform surface enables use of the curved mirror as a scanning mirror. That is, the freeform surface can be designed and optimized, e.g. using appropriate optical CAD design tools, and manufactured using freeform grinding and polishing tools, to meet imaging quality requirements such as wave front error, modulation transfer function and other aberration requirements, as well as a low surface roughness within an angular range of the tilt angles. For example, grinding may be based on ultra-precision machining such as single point diamond turning (SPDT) which may be used if the mirror substrate material is aluminum or an aluminum-silicon alloy (although also other metals are also possible). Polishing may be based on so called deterministic polishing like Magneto Rhealogical Finishing (MRF) or Ion Beam Figuring (IBF).

According to an embodiment, the scanning direction is parallel with the along track direction or defines an angle less than or equal to 90 degrees relative to the along track direction.

By having the scanning direction parallel with the along track direction the signal-to-noise ratio can be maximized, while an angle, such as an angle in the range from 0 to 90 degrees, enables a larger area of the surface to be imaged or to provide a higher revisit frequency to specific surfaces on the Earth.

According to an embodiment, the imaging system is configured to limit the field of view along a first direction on the surface of the astronomical body as compared with the field of view along a second direction perpendicular to the first direction.

The first direction and the along track direction may be the same or substantially the same. Further, the first direction may be the same or substantially the same as the scanning direction, which again may be the same or substantially the same as the along track direction. In an embodiment the slit aperture is arranged to generate the limited field of view in the first direction. For example, the slit aperture is rectangular and is arranged so that the first direction of the field of view is imaged along a shortest dimension of the slit aperture.

The slit aperture generally has a short dimension in one direction and a long dimension in a perpendicular direction. The short dimension limits the field of view, but the long dimension may also generate a limitation of the field of view in the perpendicular direction.

According to an embodiment, the image sensor has a rectangular sensor area and is arranged so that the first direction of the field of view is imaged along a shortest dimension of the sensor area.

According to an embodiment, the imaging system comprises a chromatic dispersion element arranged to disperse light along a direction on the image sensor which is parallel to the imaged scanning direction.

The chromatic dispersion element enables spectrally resolved imaging of the surface of the Earth by combining the chromatic dispersion element with a limitation in the field of view, e.g. by use of a slit aperture, so that the light is dispersed in the direction of the limited field of view—e.g. dispersed in the direction of the shortest dimension of the slit aperture—and the image sensor is arranged to record the dispersed light along the imaged along track direction.

According to an embodiment, the imaging system comprises a chromatic filter element arranged to transmit light towards the image sensor, wherein the chromatic filter element has different transmission coefficients that varies dependent on wavelength along a direction on the image sensor which is parallel to the imaged scanning direction.

Similarly to the chromatic dispersion element, the chromatic filter element enables spectrally resolved imaging of the surface of the Earth.

According to an embodiment, the imaging system comprises a plurality of rectangular slit apertures arranged so that the first direction of the field of view is imaged along the short dimensions of the slit apertures.

Advantageously, the multiple slit apertures can be combined with different chromatic dispersion elements or chromatic filter elements and associated different image sensors to provide multiple imaging functionalities, e.g. imaging of different spectral ranges.

The line of sight scanning range of the actuator in the scanning direction may be less than +/−5 degrees, less than +/−1 degree, less than +/−10 arcmin, less than +/−5 arcmin, less than +/−3 arcmin, such as less than +/−2 arcmin.

According to an embodiment, the mirror arranged for tilting, i.e. the tiltable mirror, has the smallest diameter among the curved mirrors. Advantageously, a smaller and lighter actuator is required for the smaller and lighter mirror.

According to an embodiment, the telescope is based on a three-mirror anastigmat design.

A second aspect of the invention relates to a telescope system for a flying platform such as a satellite, comprising
the imaging system according to the first aspect,
a control system arranged to control the tilt of the actuator system dependent on the motion of the flying platform relative to the astronomical body so that an area of the surface is imaged to the same or substantially the same portion of the image sensor at least for two locations of the platform within at least fraction of the trajectory.

A third aspect of the invention relates to a satellite or aircraft comprising the telescope system of the second aspect.

A fourth aspect of the invention relates to a method for imaging a surface of an astronomical body, such as the Earth, from a flying platform such as an orbiting satellite comprising an imaging system, wherein a line of sight of the imaging system on the surface during the flight defines an along track direction, the method comprises
imaging the surface using a telescope comprising at least first and second curved mirrors wherein the second mirror is located downstream of the first mirror relative to a propagation direction of imaged light,
forming an image on a digital image sensor or within a slit aperture arranged at the focal plane of the telescope,
tilting the second mirror or other curved mirror located down-stream of the first curved mirror for scanning the line of sight of the imaging system in a scanning direction on the surface within a field of view of the imaging system.

In general, the various aspects and embodiments of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIGS. 1A and 1B shows an optical design example of a telescope for a satellite imaging system,

FIG. 2 defines relevant directions for use of a satellite with an imaging system orbiting the an astronomical body such as the Earth,

FIG. 3 a sketch of the satellite flying in orbit around an astronomical body, and

FIG. 4A shows a principal sketch of a telescope system for a satellite, and

FIG. 4B shows an example of the imaging system in combination with a dispersion element.

### DETAILED DESCRIPTION OF AN EMBODIMENT

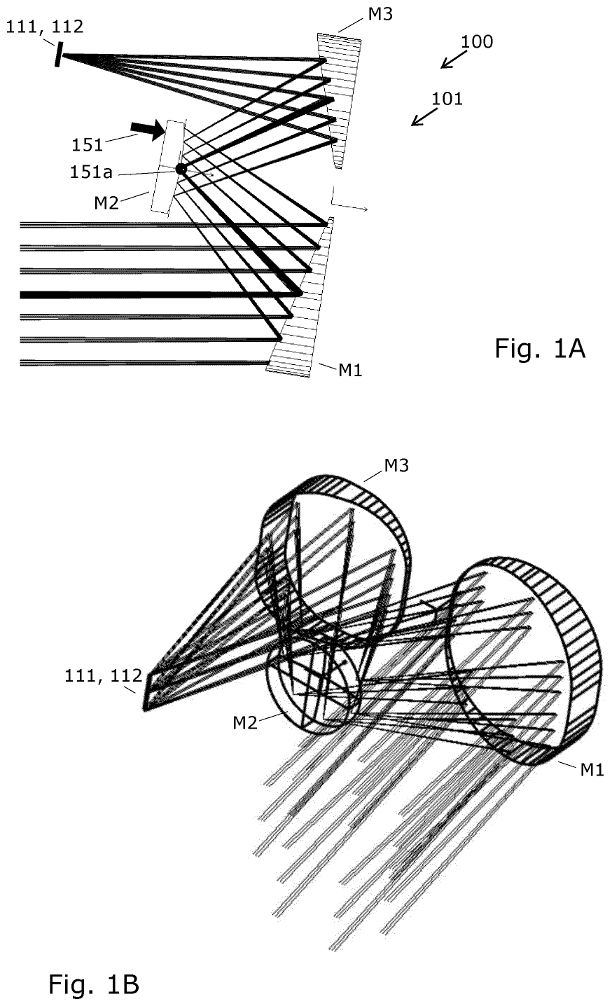

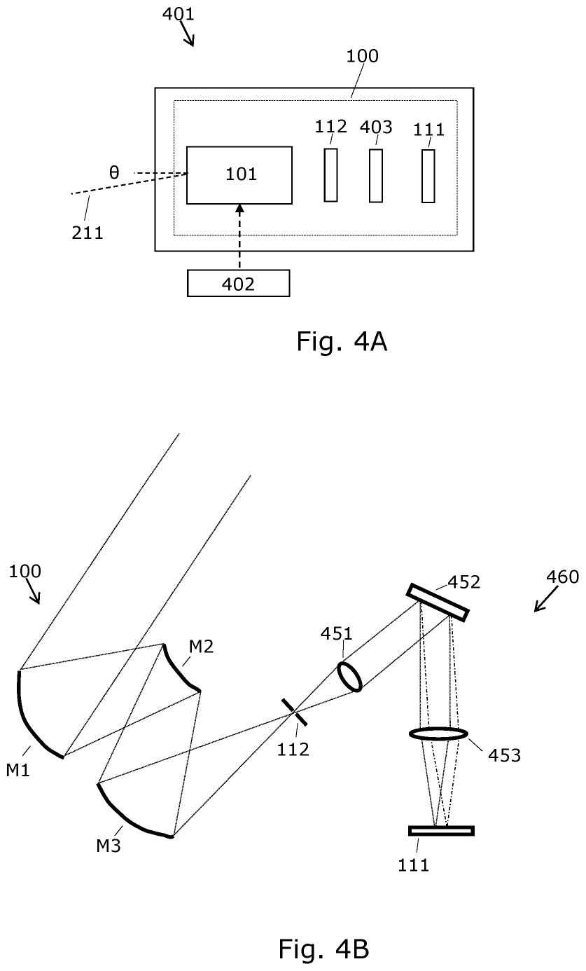

FIGS. 1A and 1B show an example of a telescope 101 of a satellite imaging system 100. The telescope which may be based on a three-mirror anastigmat design, but could also be based on other designs, comprises first, second and third mirrors M1, M2, M3. Dependent on the optical design the telescope comprises at least first and second curved mirrors M1, M2. The imaging system 100 further comprises an image sensor 111 which may have a rectangular or square pixel area and with pixels arranged in two dimensions for recording 2D images, or with pixels arranged in one dimension for recording 1D images. Alternatively or additionally to the image sensor 111, the imaging system 100 may comprise a slit aperture 112, i.e. a rectangular aperture. The image sensor 111 would be placed at the focal plane of the telescope 101, such as at the focal plane of the least first and second curved mirrors M1, M2. Similarly, the slit aperture 112 may be placed at the focal plane of the telescope 101. In case the slit aperture 112 is placed at the focal plane of the telescope 101, a further imaging lens or imaging lens system 453 may be arranged to image the slit aperture 112 onto an image sensor. The example shown in FIG. 4B includes such a further image system 453 and additionally a dispersion element 452.

The first mirror M1 is the first mirror in the propagation direction of the light to be imaged, while the one or more subsequent mirrors M2, M3 are located downstream of the first mirror in the propagation direction of light towards e.g. the image sensor 111.

The satellite imaging system 100 further comprises an actuator system 151, principally illustrated in FIG. 1A. The actuator system is arranged for tilting the second mirror M2 or other curved mirror located down-stream of the first curved mirror M1, such as the third mirror M3. The actuator system may be arranged for tilting the mirror about one axis 151a, but could be arranged for tilting the mirror about more than one axis or about a point. Advantageously, the tilting axis 151a or pivot point may be located on the mirror surface as illustrated to reduce aberrations while tilting.

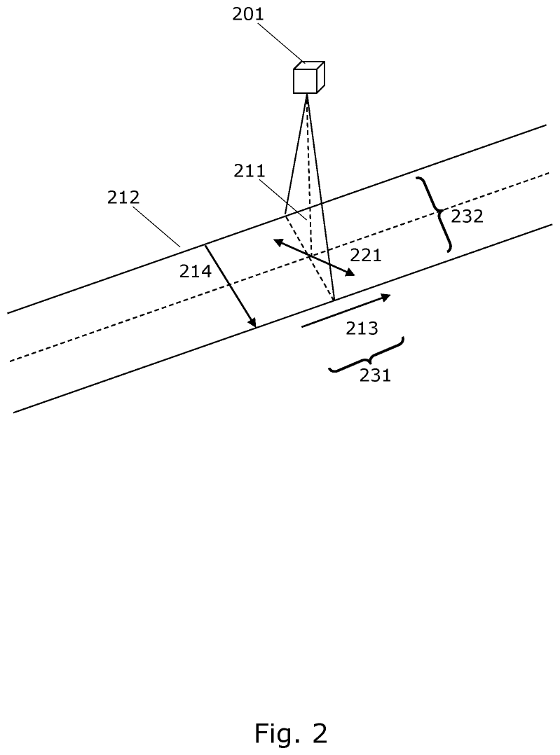

FIG. 2 shows a satellite 201 comprising the satellite imaging system 100 orbiting the Earth or other astronomical body such as a moon and other planets. Accordingly, while the examples herein refer to Earth imaging, the satellite imaging system can be used for imaging surfaces of other astronomical bodies. The imaging system 100 is oriented towards the Earth so that the line of sight 211 of the imaging system follows a track 212 on the surface of the Earth.

Further, whereas FIG. 2 refers to the use of the imaging system 100 on an orbiting satellite 201, the imaging system may equally be used on other platforms capable of flying along a trajectory at a distance to the astronomical body such as the Earth. Examples of the platform comprise manned or unmanned aircrafts, like airplanes and unmanned aerial vehicles and aerostats.

Thus, whereas examples herein refer to satellites, the imaging system may equally be used on other flying platforms flying along a trajectory. The flying path of the platform or an orbit of a satellite are commonly referred to as the trajectory of the platform. Any example or definition herein referring to the orbit of a satellite applies equally to the trajectory of a platform.

An aircraft flying along a trajectory above the surface of the Earth will have a lower speed than a satellite. However, the scanning parameters of the imaging system 100 for a satellite may also apply for an use on an aircraft since altitude and speed scale similarly. Thus, scanning speeds of the tilt mirror M2 for a satellite imaging system may also be used for an imaging system designed for an aircraft where the imaging system is designed for a smaller ground sampling distance, e.g. in the order to 20 cm or smaller.

The line of sight is defined as the direction from the satellite 201 to a center point of the area of the surface that is currently imaged.

The moving direction of the line of sight 211 along the track 212, or equivalently the flight direction of the satellite, defines the along track direction 213. The direction perpendicular to the along track direction 213 is the across track direction 214.

The field of view of the imaging system 100 defines the extent of the surface of the Earth that is imaged. The imaging system 100 may have a field of view 231 along a first direction, such as in the along track direction 213 which is equal to, or different from, the field of view 232 in a second direction, such as in the across track direction 214. The first and second directions are perpendicular or substantially perpendicular.

The imaging system 100 is configured so that when the actuator system tilts the second mirror M2 or other curved mirror back and forth, the line of sight 211 scans the surface within the track 212, back and forth, along a scanning direction 221 on the surface of the Earth within the field of view of the imaging system.

The scanning direction need not be parallel with the along track direction 213, but could have an angle relative to the along track direction 213. According to an embodiment, the scanning direction 221 is parallel or substantially parallel with the along track direction 213.

For example, the second mirror M2 may be tilted back and forth to scan the line of sight 211 along a scanning direction 221 at 45 degrees relative to the along track direction 213 to increase the imaged area of the surface, or to increase the revisit frequency to specific places on the Earth surface.

The different field of view dimensions, or equivalently angles, need not be aligned with the along and across track directions 213, 214. Thus, in general the field of view may be defined in first and second perpendicular directions on the surface of the Earth, where the field of view in the first direction is limited as compared with the field of view along a second direction. The first direction may be parallel or substantially parallel with the scanning direction, or may be parallel or substantially parallel with the along track direction 213.

The field of view in the first and second directions, such as in the along and across track directions 213, 214 may be achieved by the limiting dimensions of the slit aperture 112 or the image sensor 111. Thus, the slit aperture, which has a rectangular aperture, may be is arranged so that the first direction of the field of view, e.g. the along track direction, is imaged along a shortest dimension of the slit aperture. Consequently, the second direction of the field of view, e.g. the across track direction, is imaged along the long dimension of the slit aperture. The long dimension may have a length which limits the field of view or may be configured with a length which does not limit the field of view in that direction.

Similarly, when the image sensor has a rectangular sensor area, the image sensor may be arranged so that the first direction of the field of view, e.g. the along track direction, is imaged along a shortest dimension of the sensor area.

Instead of a single slit aperture 112, the imaging system may be configured with a slit member comprising a plurality of rectangular slit apertures and arranged so that the first direction of the field or the along track direction 213 is imaged along the short dimensions of the slit apertures. In this case, different areas of the Earth surface would be imaged to different slit apertures. For example, different slit apertures may be used with different chromatic dispersion elements located downstream of the slit apertures, where the different chromatic dispersion elements have different spectral ranges.

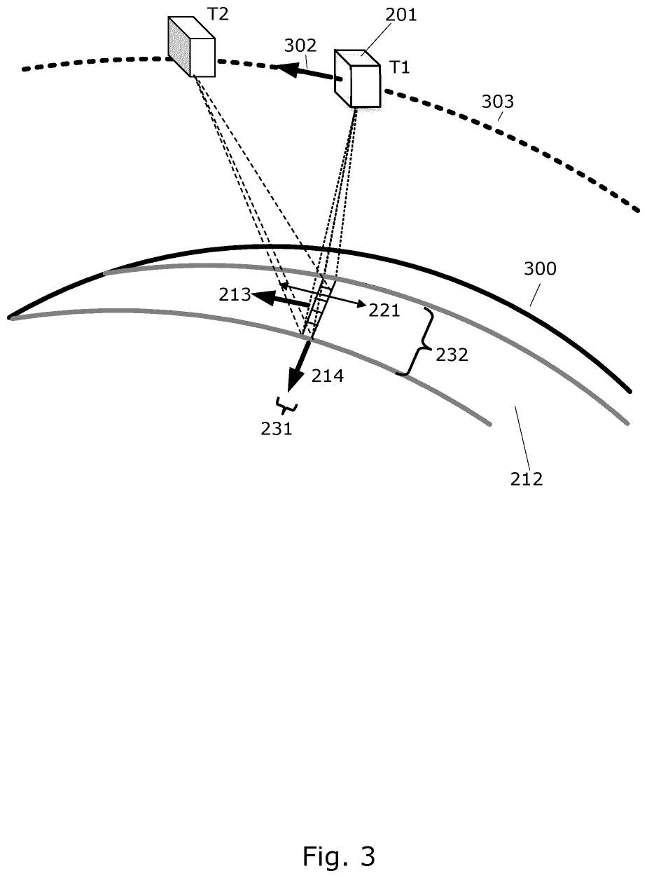

FIG. 3 shows a sketch of the satellite 201 flying in orbit 303 with flying direction 302. Reference is made to FIG. 2 for reference numbers of FIG. 3 already presented in FIG. 2.

FIG. 3 shows an example where the field of view has been limited in the along track direction 213 to the field of view 231 in that direction. For example, the field of view may be limited so that the extension of the field of view 231 is imaged onto a single row or a few row of pixels on the image sensor 111.

The mirror arranged to be tilted, such as the second mirror M2, is actuated so that the line of sight 211 is scanned in scanning direction 221 parallel or substantially parallel with the along track direction 213.

The actuator system 151 is controlled by a control system arranged to control the tilt of the actuator system dependent on the motion of the satellite relative to the astronomical body so that an area of the surface is imaged to the same or substantially the same portion of the image sensor at least for two locations of the satellite along a fraction of the orbit, i.e. a fraction of the orbit of a total revolution of Earth. The two locations are principally indicated in FIG. 3 at times T1 and T2. Thus, the same area of the surface may be imaged to the same or substantially the same portion of the image sensor continuously between two locations of the satellite along a fraction of the orbit.

That is, the tilt of the mirror may be controlled to change gradually so that the same surface defined by the extension of the field of views 231, 232 in the along track and across track directions is imaged to the image sensor while the satellite flies, e.g. during the time interval from T1 to T2.

For example, the control system may use star tracking and/or image analysis of surface features on the Earth in a feedback control system to control the tilt of the actuator system.

Thus, by controlling the tilt of the mirror, the same area on the surface of the Earth is imaged to the same location, i.e. the same pixels or substantially the same pixels on the image sensor, at least for period of time. The increased integration time increases the signal-to-noise ratio so that a higher image quality can be obtained.

In general, the image sensor 111 has a rectangular sensor area. The rectangular dimensions, i.e. both 2D directions of the rectangle, may be equal or substantially equal, and thereby form a square sensor area. Alternatively, the rectangular sensor area may have different dimensions in perpendicular directions, e.g. one dimension could be significantly smaller than the other, e.g. the sensor may be a single pixel row line detector so that the short dimension is formed by the extension of a single pixel.

The use of a curved mirror for scanning the line of sight 211 make other scanning mirrors unnecessary which only serve the scanning purpose. However, in order to reduce imaging aberrations and spatial resolution within a sufficiently large scanning range, a normal spherical, aspherical or parabolic shape of the mirror is insufficient.

Therefore, at least the curved mirror arranged to be tilted by the actuator 151, such as the second mirror M2, possibly all the curved mirrors M1-M3 has a freeform surface shape, which is a surface with an irregular shape, that does not have any axis of symmetry. Accordingly, the free-form surface does not have any continuous translation symmetry or continuous rotational symmetry.

By use of the freeform surface, the at least one freeform mirror can be designed without constraints on the surface to minimize aberrations within a specified scanning range of the line of sight 211.

The scanning range in the scanning direction 221 would be less than +/−5 degrees, less than +/−1 degree, less than +/−10 arcmin, less than +/−5 arcmin, less than +/−3 arcmin, such as less than +/−2 arcmin. The lager scanning ranges may be feasible, e.g. when larger aberrations are tolerated, whereas smaller ranges may be required when smaller aberrations are required.

The imaging system may be arranged to function with a chromatic dispersion element such as a prism, a grating or other optical component capable of dispersing incoming light in different angles dependent on the wavelength. The chromatic dispersion element is arranged so that imaged light is dispersed along a direction on the image sensor 111 which is parallel or substantially parallel to the imaged scanning direction 221 or the imaged along track direction 213. The chromatic dispersion element may be used in combination with a limited field of view, e.g. in combination with a slit aperture 112. For example, when the field of view 231 is limited in the along track direction 213, e.g. limited so that the extension of the field of view 231 is imaged to a single row or a low number of rows of pixels, the chromatic dispersion element is arranged so that light is dispersed along a direction on the image sensor 111 which is perpendicular or substantially perpendicular to the direction on the image sensor 111 where the across track direction 214 is imaged.

For example, the slit aperture 112 may be arranged at the focal plane of the telescope 101, and the chromatic dispersion element may be arranged downstream of the slit aperture 112. A further imaging lens or lens system may be arranged to image the slit aperture 112 on the image sensor.

Instead of a chromatic dispersion element, a chromatic filter element may be arranged on or in front of the image sensor. The chromatic filter element is arranged with spectrally dependent transmission coefficients that vary in a direction on the image sensor which is parallel to the imaged scanning direction 221. The spectrally different transmission coefficients, e.g. different filter or transmission colours, of the filter element may vary so that one area of the filter with a first transmission coefficient covers a first area on the image sensor 111, such as one or more rows of pixels extending across the image sensor along the direction perpendicular to the imaged scanning direction 221.

FIG. 4A shows a principal sketch of a telescope system 401 for a satellite 201. The telescope system 401 comprises the imaging system 100 which comprises the telescope 101, the image sensor 111 or the slit aperture 112. The chromatic dispersion element or chromatic filter element 403 may be comprised by the telescope system 401, e.g. comprised by a further optical system such as a further optical lens or lens system located downstream of the imaging system 100. The telescope system 401 further comprises a control system 402 arranged to control the tilt of the actuator system and thereby the scanning angle θ of the imaging system's line of sight 211. The telescope system 401 may include other components such as electronic circuits. The illustrated image sensor 111, slit aperture 112, and the chromatic dispersion or filter element 403 only illustrates a possible arrangement, while other arrangements are also possible.

FIG. 4B shows an example of the imaging system 100 with the slit aperture 112 arranged at the focal plane and a chromatic dispersion element 452 arranged downstream of the slit aperture 112. The system includes a further optical system 460 comprising the chromatic dispersion element 452, a collimation system 451, and an imaging lens or lens system 453 arranged to image the slit aperture 112 on the image sensor 111. Due to the dispersion element 452, different colours are imaged to distinguishable locations such as different pixels on the image sensor 111.

1. An imaging system for imaging a surface on an astronomical body, such as the Earth, from a platform flying along a trajectory, wherein a line of sight of the imaging system on the surface during the flight defines an along track direction, the imaging system comprises
a telescope comprising at least first and second curved mirrors wherein the second mirror is located downstream of the first mirror, relative to a propagation direction of imaged light,
a digital image sensor or a slit aperture arranged at the focal plane of the telescope, and
an actuator system arranged for tilting the second mirror or other curved mirror located downstream of the first curved mirror for scanning the line of sight of the imaging system in a scanning direction on the surface within a field of view of the imaging system.

2. An imaging system according to claim 1, wherein at least the curved mirror arranged for tilting has a surface without any axis of symmetry, such as a freeform surface.

3. An imaging system according to claim 1, wherein the scanning direction is parallel with the along track direction or defines an angle less than or equal to 90 degrees relative to the along track direction.

4. An imaging system according to claim 1, wherein the imaging system is configured to limit the field of view along a first direction on the surface of the astronomical body as compared with the field of view along a second direction perpendicular to the first direction.

5. An imaging system according to claim 4, wherein the first direction and the along track direction are the same or substantially the same.

6. An imaging system according to claim 4, wherein the slit aperture is arranged to generate the limited field of view in the first direction.

7. An imaging system according to claim 6, wherein the slit aperture is rectangular and is arranged so that the first direction of the field of view is imaged along a shortest dimension of the slit aperture.

8. An imaging system according to claim 4, wherein the image sensor has a rectangular sensor area and where the image sensor is arranged so that the first direction of the field of view is imaged along a shortest dimension of the sensor area.

9. An imaging system according to claim 1, comprising a chromatic dispersion element arranged to disperse light along a direction on the image sensor which is parallel to the imaged scanning direction or the imaged along track direction.

10. An imaging system according to claim 1, comprising a chromatic filter element arranged to transmit light towards the image sensor, wherein the chromatic filter element has different transmission coefficients that varies dependent on the wavelength along a direction on the image sensor which is parallel to the imaged scanning direction or the imaged along track direction.

11. An imaging system according to any of claim 4, comprising plurality of rectangular slit apertures arranged so that the first direction of the field of view is imaged along the short dimensions of the slit apertures.

12. An imaging system according to claim 1, wherein a line of sight scanning range of the actuator in the scanning direction is less than +/−5 degrees, less than +/−1 degree, less than +/−10 arcmin, less than +/−5 arcmin, less than +/−3 arcmin, such as less than +/−2 arcmin.

13. An imaging system according to claim 1, wherein the mirror arranged for tilting has the smallest diameter among the curved mirrors.

14. An imaging system according to claim 1, wherein the telescope is based on a three-mirror anastigmat design.

15. An imaging system according to claim 1, wherein the flying platform is a satellite, a manned or unmanned aircraft, an aerostats or other airborne system.

16. A telescope system for a flying platform, comprising
the imaging system according to claim 1,
a control system arranged to control the tilt of the actuator system dependent on the motion of the flying platform relative to the astronomical body so that an area of the surface is imaged to the same or substantially the same portion of the image sensor at least for two locations of the flying platform within at least a fraction of the trajectory.

17. A telescope system of claim 16 further comprising a satellite or aircraft.

18. A method for imaging a surface of an astronomical body, such as the Earth, from a flying platform comprising an imaging system, wherein a line of sight of the imaging system on the surface during the flight defines an along track direction, the method comprises
imaging the surface using a telescope comprising at least first and second curved mirrors wherein the second mirror is located downstream of the first mirror relative to a propagation direction of imaged light,
forming an image on a digital image sensor or within a slit aperture arranged at the focal plane of the telescope,
tilting the second mirror or other curved mirror located down-stream of the first curved mirror for scanning the line of sight of the imaging system in a scanning direction on the surface within a field of view of the imaging system.
